(19) United States
(12) Patent Application Publication
(10) Pub. No.: US 2003/0126201 A1
(43) Pub. Date: Jul. 3, 2003

(54) Efficient storage of data files received in a non-sequential manner

(76) Inventor: Khoi Hoang, Pleasanton, CA (US)

Correspondence Address: PERKINS COIE LLP, P.O. BOX 2168, MENLO PARK, CA, 94026, US

(21) Appl. No.: 10/206,791

(22) Filed: Jul. 26, 2002

Related U.S. Application Data
(60) Provisional application No. 60/337,280, filed on Nov. 30, 2001.

(51) Int. Cl. G06F 15/16; G06F 13/28; G06F 12/00

(52) U.S. Cl. 709/203; 711/152

(57) ABSTRACT

The present invention contemplates several data storage mechanisms well suited for high speed storage of data files received as non-sequential data blocks. In one preferred embodiment, data blocks are stored in an order received, and the proper sequencing of these data blocks is maintained in a separate data structure. This minimizes total seek time during data storage, and enables sequential retrieval of the file data blocks. In another preferred embodiment, a receiver allocates multiple portions of persistent memory to each data file. This approach balances total seek time during storage, with total seek time during file retrieval as well as alleviating some of the effects of memory fragmentation which arise when persistent memory is released as stored files are deleted.

### RELATED APPLICATIONS AND CROSS REFERENCES

This application claims priority to and fully incorporates by reference the following provisional patent application by Khoi Hoang:

RANDOM STORE OF NON CLIENT SPECIFIC ON-DEMAND DATA filed on Nov. 30, 2001, bearing application Ser. No. 60/337,280.

This application also claims priority to and fully incorporates by reference the following patent application by Khoi Hoang:

NON CLIENT SPECIFIC ON-DEMAND DATA BROADCAST filed on May 31, 2000, bearing application Ser. No. 09/584,832.

### FIELD OF THE INVENTION

This invention relates to digital data management and, more specifically, to methods and systems for storing data files received as non-sequential data blocks.

### BACKGROUND OF THE INVENTION

When a digital data server transmits one or more digital data files to a digital data receiver, the data from each data file is typically arranged into data blocks and multiplexed for transmission. To capture and store each data file, the receiver allocates persistent memory (e.g., a hard disk space) for each file and stores each received data block in a file sequential manner within the corresponding persistent memory. That is, each received file is stored sequentially within a predefined location of the persistent memory, but not necessarily in the order in which the file data blocks are received. This is referred to hereinafter as the “file sequential data storage paradigm.”

The file sequential file data storage paradigm has certain readily apparent characteristics. Because data blocks for each file are stored sequentially within a predefined location of the persistent memory, total seek time for data file retrieval is minimized. Persistent memory for storing data files such as MPEG data files is typically a hard disk or other device where seek times for accessing memory locations are significant. Thus when rapid access to stored files is the main design criteria, the file sequential data storage paradigm makes sense. Additionally, management of data files having their blocks sequentially stored in predefined locations of persistent memory can be quite simple.

Unfortunately, the file sequential data storage paradigm is ill suited for certain situations. In short, when the data blocks are not received in a sequential manner, the retrieval efficiency of the file sequential data storage paradigm comes only at the expense of decreased storage speed. This is because when data blocks are received non-sequentially yet stored in a file sequential manner, a seek time is required to write each received data block. The total seek time for data storage tends to prevent full use of the communication bandwidth available between the digital data server and the digital data receiver. In many applications data is received and must be stored at a much higher rate than is required for real time access of the received data files by a user. In these situations, the data retrieval efficiency of the file sequential data storage paradigm provides little benefit to the user.

Based on the foregoing, there is a need for a method or mechanism for storing received data in a manner such that the total seek time during the storage of the data is kept to a minimum.

### SUMMARY OF THE INVENTION

The present invention contemplates several data storage mechanisms well suited for high speed storage of data files received as non-sequential data blocks. In one preferred embodiment, data blocks are stored in an order received, and the proper sequencing of these data blocks is maintained in a separate data structure. This minimizes total seek time during data storage, and enables sequential retrieval of the file data blocks. In another preferred embodiment, a receiver allocates multiple portions of persistent memory to each data file. This approach balances total seek time during storage, with total seek time during file retrieval as well as alleviating some of the effects of memory fragmentation which arise when persistent memory is released as stored files are deleted.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a digital data system in accordance with one embodiment of the present invention;

FIG. 2 is a block diagram that illustrates the hardware architecture of a set-top-box that can be used to implement the invention;

FIG. 3 is a flowchart illustrating a data storage method providing an efficient write mechanism for storing data files received as non-sequential data blocks according to one embodiment of the present invention;

FIG. 4 is a flow chart illustrating one preferred method for generating a free memory block list according to one aspect of the present invention;

FIG. 5 is a block diagram that illustrates the division of data files into a number of data blocks;

FIG. 6 is a block diagram that illustrates the storage of a sequence data blocks that is received at a digital data receiver; and

FIG. 7 is a block diagram that illustrates index tables.

### DETAILED DESCRIPTION OF THE PREFERRED EMBODIMENT

The present invention contemplates several data storage mechanisms well suited for high speed storage of data files received as non-sequential data blocks. In one preferred embodiment, data blocks are stored in an order received, and the proper sequencing of these data blocks is maintained in a separate data structure. This minimizes total seek time during data storage, and enables sequential retrieval of the file data blocks. In another preferred embodiment, data files are arranged having large blocks so that a receiver may allocate large portions of persistent memory to each data file. This approach balances total seek time during storage, with total seek time during file retrieval as well as alleviating some of the effects of memory fragmentation which arise when persistent memory is released as stored files are deleted.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Functional and Operational Overview

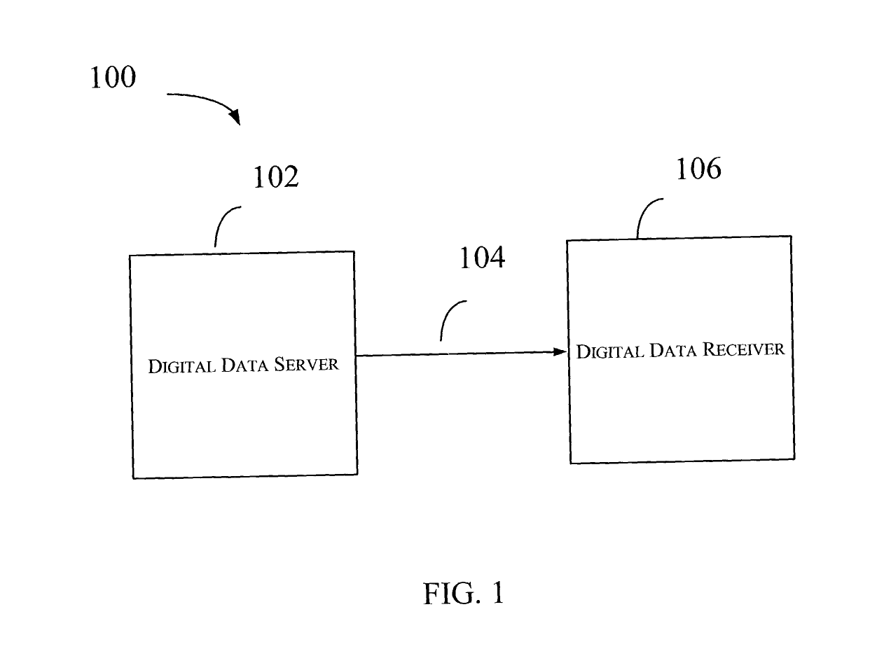

FIG. 1 illustrates a block diagram of a digital data system 100 in accordance with one embodiment of the present invention. The digital data system 100 includes a digital data server 102 coupled to a digital data receiver 106 via a network 104. As will be appreciated, the digital data system 100 is a generic architecture that may take on many suitable forms. For example, the digital data server 102 may provide digital video broadcast services, video and data on-demand services, Internet services, etc. The network 104 may take a variety of forms such as a fiber optic network, a satellite network, a cable network, a combination of different medium, may be a wide area network such as the Internet, etc. The digital data receiver 104 may be a set-top-box (STB), a personal computer, a personal digital assistant (PDA), etc.

In the context of video-on-demand (VOD) or video-on-request (VOR) services, the digital data server 102 may take the form of a remote VOR server, and the digital data receiver 106 may take the form of a STB. In this case, the VOR server broadcasts data such as MPEG-2 data files to the STB that is associated with a user services. The requester who is requesting the VOD services is herein referred to as the “customer”.

According to certain embodiments of the invention, each data file is divided into a number of data blocks and multiple data files are transmitted from the server to a client, such as a set-top box, according to a non-sequential scheduling matrix. Various techniques may be used to generate such a scheduling matrix. One such technique is described in U.S. patent application Ser. No. 09/584,832 entitled “SYSTEMS AND METHODS FOR PROVIDING VIDEO ON DEMAND SERVICES FOR BROADCASTING SYSTEMS,” filed by Khoi Nhu Hoang on May 31, 2000, the content of which is incorporated herein by reference.

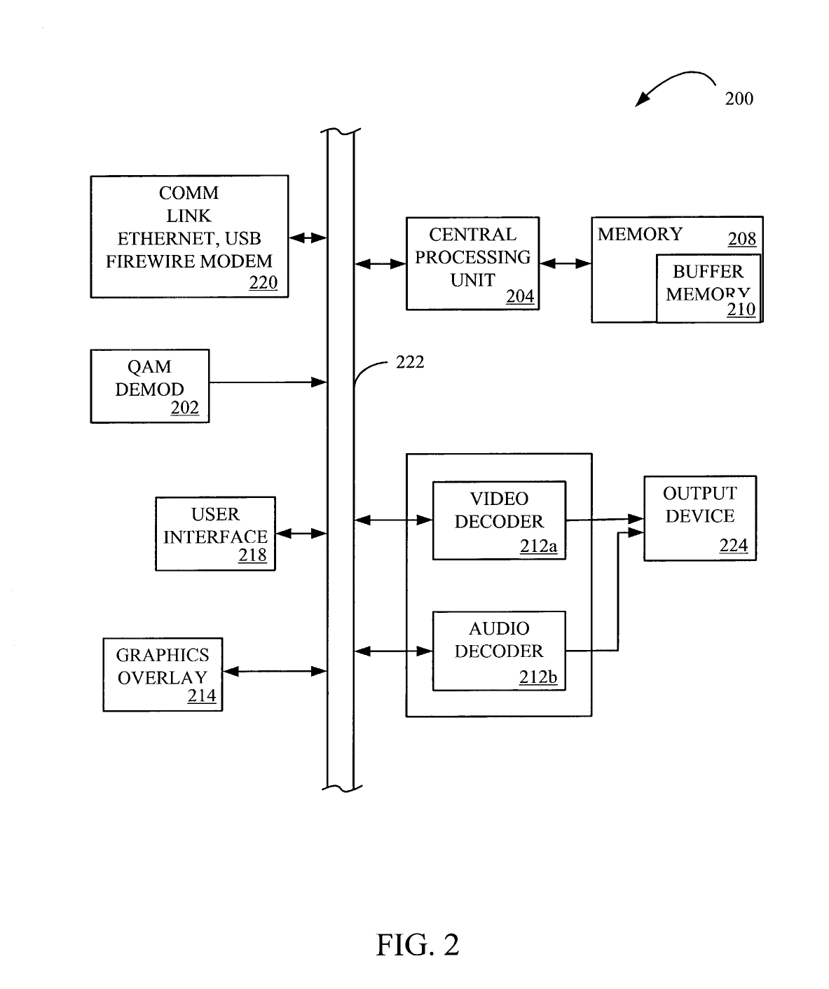

FIG. 2 is a block diagram of the hardware architecture of a STB 200 well suited for use as a digital data receiver 106 that can be used to implement the invention. However, the scope of the invention is not limited to set-top boxes. The embodiments apply, without limitation, to any system that is associated with VOD services and/or data on demand service (DOD).

The set top box 200 includes a quadrature amplitude modulation (QAM) demodulator 202, a central processing unit (CPU) 204, a local memory 208, a buffer cache 210, a decoder 212 having video and audio decoding capabilities, a graphics overlay module 214, a user interface 218, a communications link 220, and a fast data bus 222. The CPU 204 controls overall operation of the set top box 200 in order to select data in response to a customer's request, decode selected data, decompress decoded data, re-assemble decoded data, store decoded data in local memory 208 or the buffer cache 210, and deliver the stored data to decoder 212. In an exemplary embodiment, local memory 208 comprises non-volatile persistent memory (e.g. a hard drive) and the buffer cache comprises volatile memory (e.g., RAM).

According to certain embodiments, the QAM demodulator 202 comprises transmitter and receiver modules and one or more of the following: 1) privacy encryption/decryption module, 2) forward error correction decoder/encoder, 3) tuner control, 4) downstream and upstream processors, and 5) CPU and memory interface circuits. QAM demodulator 202 receives modulated intermediate frequency (IF) signals, samples and demodulates the signals to restore data.

In an exemplary embodiment, when access is granted, decoder 212 decodes at least one data block to transform the data block into images displayable on an output screen. Specifically, video decoder 212a transforms the video portion of the data block into displayable images. Audio decoder 212b transforms the audio portion of the data block into audible sound. Output device 224 may be any suitable device such as a television, computer, any appropriate display monitor, a VCR, etc.

The graphics overlay module 214 enhances displayed graphics quality by, for example, providing alpha blending or picture-in-picture capabilities.

User interface 218 enables the user control, i.e., control by the customer, of the settop box 200. User interface 218 may be any suitable device such as a remote control device, a keyboard, a smart card, etc.

Communications link 220 provides an additional communications connection. Communications link 220 may be operatively coupled to another computer, or communications link 220 may be used to implement bi-directional communication.

Data bus 222 may be a commercially available “fast” data bus that is suitable for performing data communications in a real time manner. Suitable examples of data buses are USB, firewire, etc.

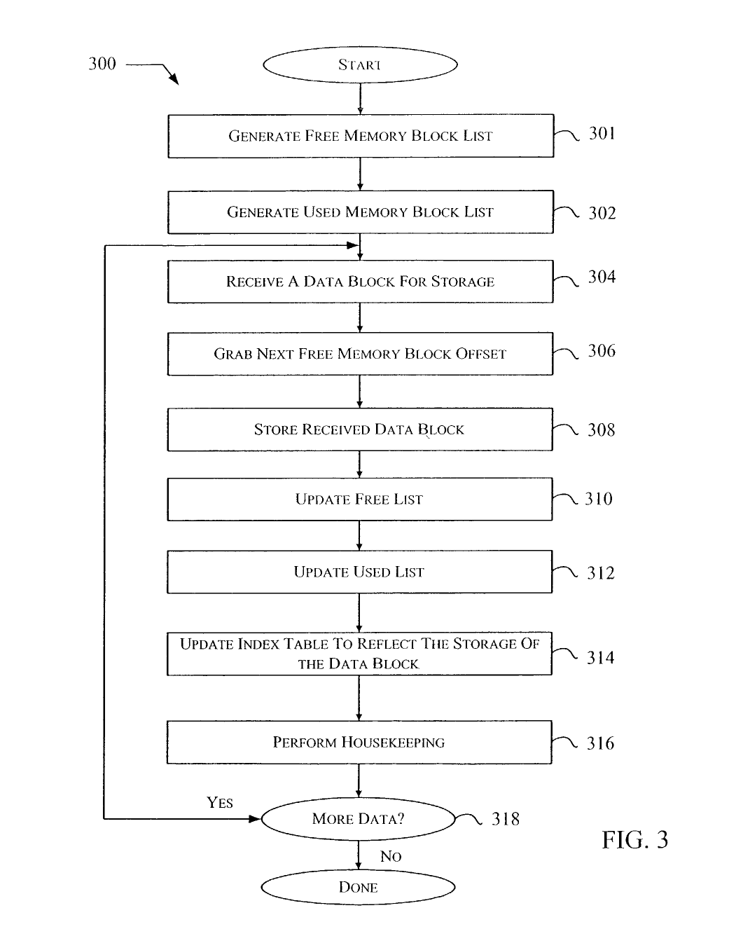

FIG. 3 is a flowchart of a data storage method 300 providing an efficient write mechanism for storing data files received as non-sequential data blocks according to one aspect of the present invention. The method 300 is well suited for applications wherein total seek time of data file storage must be minimized. The method 300 may be accomplished by a computer implemented process instantiated on a variety of devices such as a STB or a personal computer having a standard computer system architecture. Alternatively, the method 300 may be implemented utilizing an ASIC, DSP, or other such device in conjunction with non-volatile persistent and volatile transient memory. The method 300 is suitable for any type of digital data which is received in the form of data blocks; this may include MPEG data, JPEG data, etc.

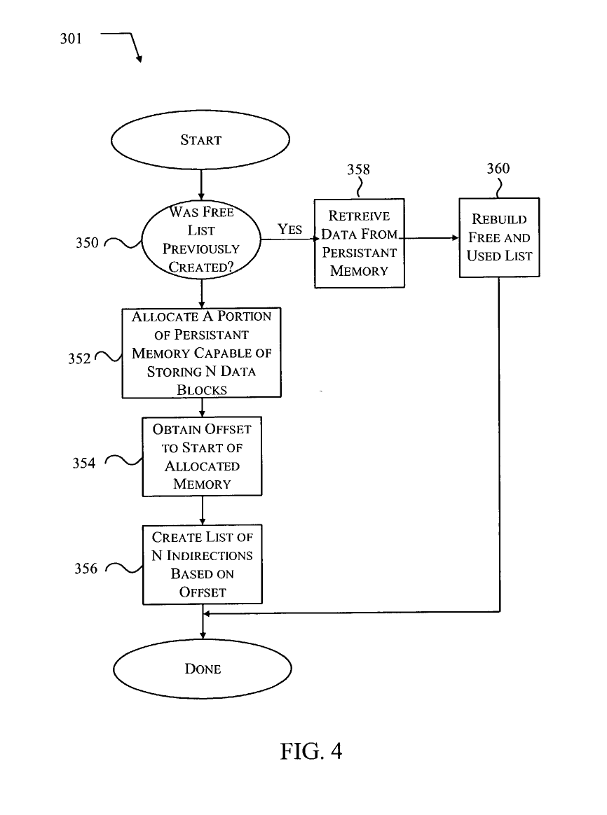

A step 301 generates a free memory block list and a step 302 generates a used memory block list. Each element of the free/used memory block list provides an indirection to a free/used portion of persistent memory allocated for a specific data block. The indirection may simply be a memory offset, or may be a true pointer, or may indirect to the next memory block location in another way known to those skilled in the art. One preferred embodiment for performing step 301 is described in more detail below with reference to FIG. 4.

A step 304 receives a data block for storage. This step assumes some preprocessing may occur. For example, data blocks that belong to a file not selected for storage or data blocks that have been received and stored previously may be immediately discarded. However, upon receipt of a next desired block, a step 306 accesses the free memory block list to grab a next free memory block indirection. Once the indirection is obtained in step 306, a step 308 stores the received data block in the portion of persistent memory indicated by the next free memory block indirection. An update free memory block list step 310 then deletes the next free memory block indirection from the free memory block list. An update used memory block list step 312 adds the next free memory block indirection to the used memory block list.

As can be seen, the method 300 of FIG. 3 generates a data structure storing multiple data files in the order of receipt of the data blocks. This differs from the prior art data storage mechanism that stores data in a file sequential manner. Storing data in the order in which the data blocks are received decreases total seek time during data writing as the data is simply written to the next sequential portion of memory. To enable sequential access to the data files, a step 314 updates a data index table to reflect the location of the received data block within the persistent memory.

A step 316 performs any necessary housekeeping. For example, in preferred embodiments the free memory block list, the used memory block list, and the index table are active in transient fast access memory. Periodically it may make sense to write these data structures into persistent memory to prevent loss during disorderly shut down and for use during future operation. Additionally, the housekeeping step 316 may determine whether the free memory list is running low. If so, more memory must be allocated for this data storage session, or perhaps unused memory must be reclaimed and the indirections added back into the list.

A step 318 determines whether more data must be retrieved. When more data must be retrieved, process control passes back to step 304 to receive a next data block. When no more data must be retrieved, or when the process is idle, the method 300 is done.

FIG. 4 is a flow chart illustrating one preferred method for performing the generate free memory block list step 301 of FIG. 3. The method 301 must be performed at the start of each data storage session. A step 350 determines whether a free memory block list has previously been created. The present invention contemplates that data blocks from data files may be accumulated over one or more sessions. Hence persistent memory may already be allocated and files partially stored when the method of receiving certain data files begins.

In an initial state when no free memory block list has been created, flow control passes to a step 352 that allocates a portion of persistent memory capable of storing N data blocks. Typically another process will control access to the persistent memory and a request for allocation of memory for N data blocks is responded to with an offset indirecting to the start of memory for the first data block. A step 354 obtains the offset indirecting to the beginning of the allocated persistent memory. A step 356 creates a free memory block list comprising N indirections to N memory locations based on the received offset.

When a free memory block list has previously been created, flow control passes from step 350 to a step 358 that retrieves from persistent memory information required to rebuild the free and used memory block lists. A step 360 rebuilds the free and used memory block lists in a sorted format suitable for storing incoming data blocks.

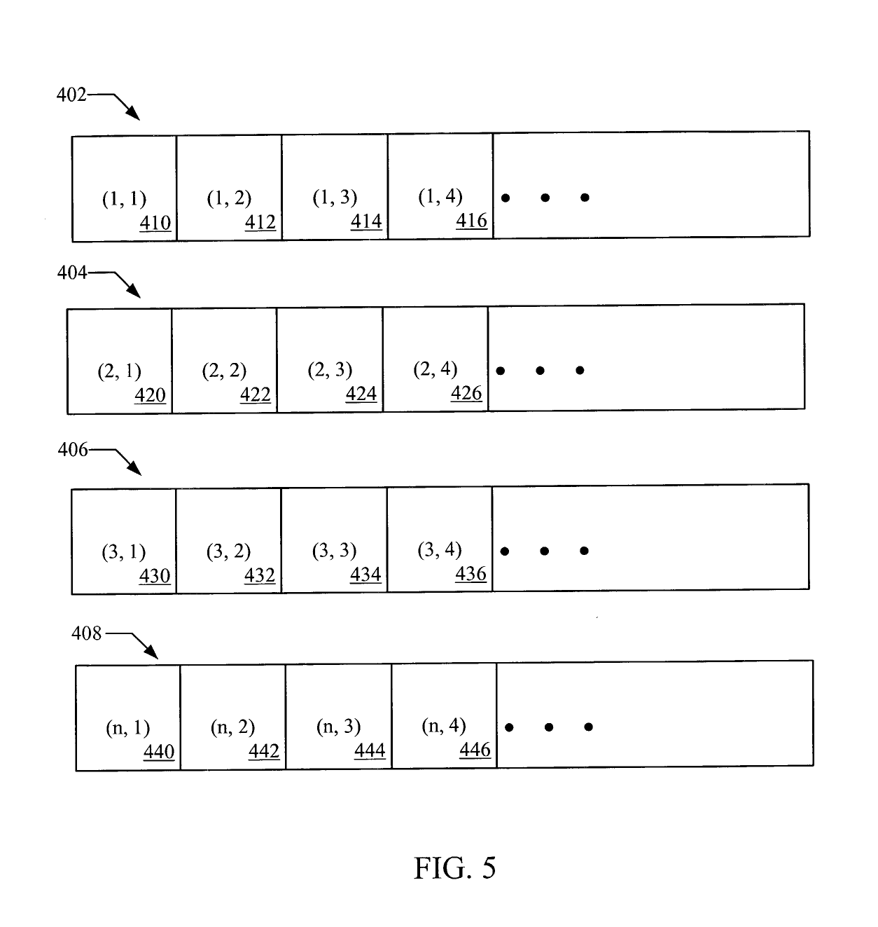

FIGS. 5-7 will now be used to show how the data structures of the present invention evolve for one possible order of data block receipt. FIG. 5 is a block diagram that illustrates the division of data files into a number of data blocks. For later reference, the labeled elements of these data files will now be enumerated. Data file 402 is divided into a number of data blocks such as data blocks 410, 412, 414, and 416. Similarly, data file 404 is divided into a number of data blocks such as blocks 420, 422, 424, and 426, data file 406 is divided into a number of data blocks such as blocks 430, 432, 434, and 436, and data file 408 is divided into a number of data blocks such as blocks 440, 442, 444, and 446.

Data block 410 is the first data block in data file 402, and is indicated by the notation (1,1). The first numeral in notation (1,1) represents the file number of the data file. The second numeral in the notation (1,1) represents the block number within the given data file, which is data file 402, in this example. Similarly, block 412 is the second data block in data file 402, and is indicated by the notation (1,2). Block 414 is the third data block in data file 402, and is indicated by the notation (1,3). Block 416 is the fourth data block in data file 402, and is indicated by the notation (1,4), etc. This nomenclature carries through to all the data files 404-408, and will not be explained further as it is self-evident.

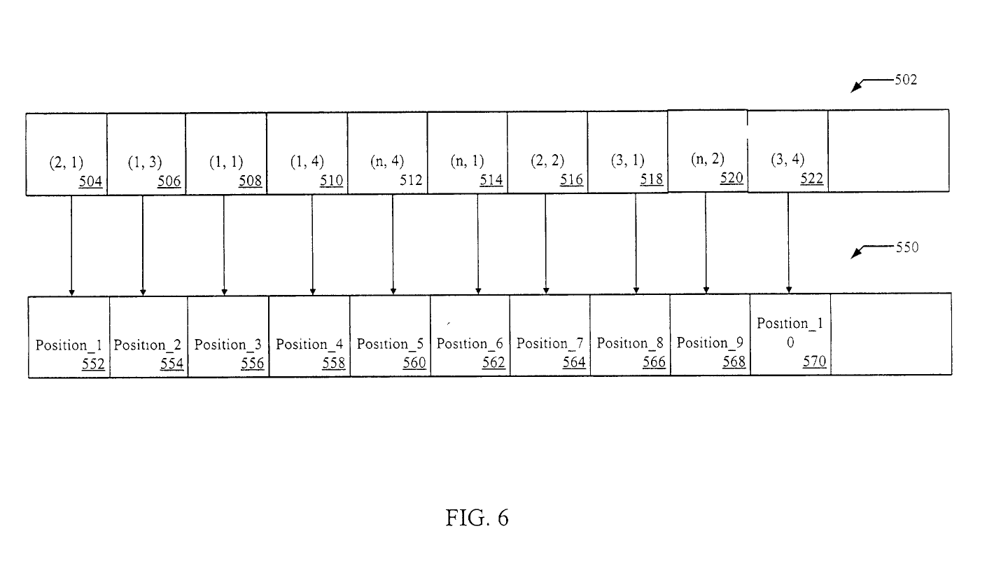

FIG. 6 illustrates the mapping from an example sequence of received data blocks to storage in persistent memory. A list 502 is a list of data blocks FIG. 5 arranged in a sequence of receipt. The list 502 has elements 504, 506, 508, 510, 512, 514, 516, 518, 520, 522. Note that each of these elements correspond to a specific data block, and that these are non-sequential with respect to the files the received data blocks correspond.

The data structure 550 is the portion of persistent memory storing the data blocks received of the received list 502. That is, each element of list 502 has information on the storage location of its corresponding data block. In this specific example, the mapping for each element in the list 502 is as follows:

1) element 504 is mapped to address information having the value, “Position_{—}1” 552,

2) element 506 is mapped to address information having the value, “Position_{—}2” 554,

3) element 508 is mapped to address information having the value, “Position_{—}3” 556,

4) element 510 is mapped to address information having the value, “Position_{—}4” 558,

5) element 512 is mapped to address information having the value, “Position_{—}5” 560,

6) element 514 is mapped to address information having the value, “Position_{—}6” 562,

7) element 516 is mapped to address information having the value, “Position_{—}7” 564,

8) element 518 is mapped to address information having the value, “Position_{—}8” 566,

9) element 520 is mapped to address information having the value, “Position_{—}9” 568,

10) element 522 is mapped to address information having the value, “Position_{—}10” 570, etc.

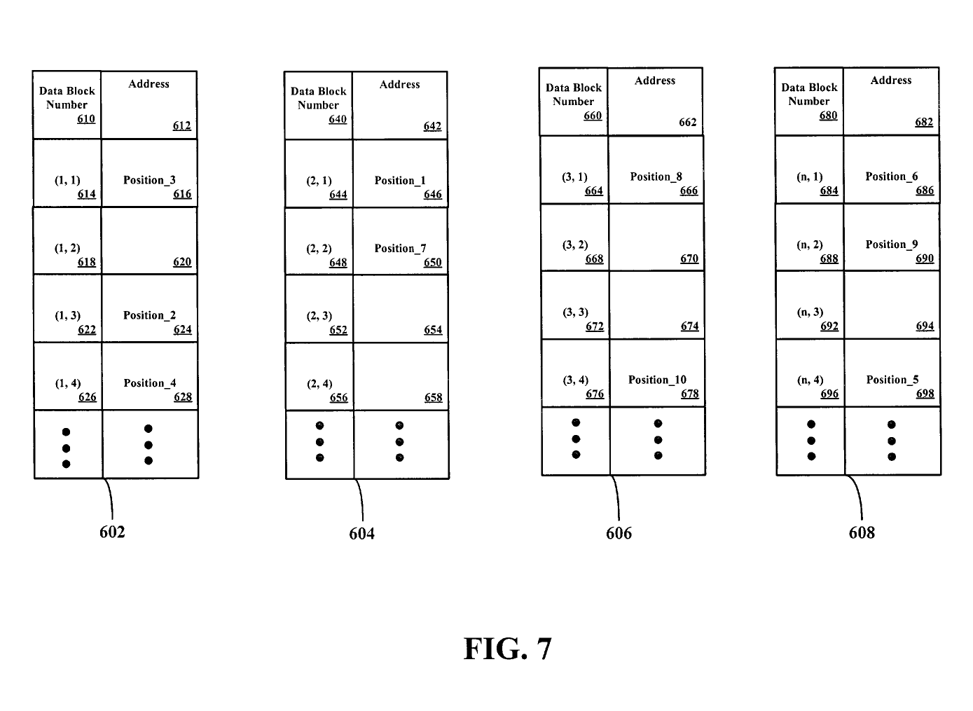

As described above with reference to step 314 of FIG. 3, an index table is created for each data file so that the stored data blocks may be accessed in a sequential manner. FIG. 7 is a block diagram that illustrates index tables created for each of the data files when the data blocks are received as provided by the example receive list 502 of FIG. 6.

FIG. 7 illustrates index tables 602, 604, 606, and 608 that correspond to data file 402, data file 404, data file 406, and data file 408 of FIG. 5, respectively.

Index table 602 includes a data block number column 610 and an address column 612. Data block number column 610 includes the data block numbers of the data blocks from data file 402, such as data block (1,1) 614, (1,2) 618, (1,3) 622, (1,4) 626, etc.

The index tables are periodically updated to fill the address column with values based on the data blocks that are stored in the list in the manner described herein. Each of the address columns of index tables 602, 604, 606, and 608 in FIG. 7 are described with reference to the list 502 of FIG. 6.

Address column 612 comprises address information 616, 620, 624, and 628, etc. Based on the mapping between the elements in the list 502 and the address information of block 550 of FIG. 6, the address column 612 of index table 602 is as follows:

1) address information 616 contains the value, “position_{—}3”,

2) address information 620 contains a null value until index table 602 is updated to include information based on the list 502, i.e., index table 602 when MPGEG-2 data block (1,2) is stored in the list 502,

3) address information 624 contains the value, “position_{—}2”,

4) address information 628 contains the value, “position_{—}4”, etc.

Similarly, index table 604 comprises a data block number column 640 and an address column 642. Data block number column 640 comprises the data block numbers of the data blocks of data file 404, such as data block (2,1) 644, (2,2) 648, (2,3) 652, (2,4) 656, etc.

Address column 642 of index table 604 in FIG. 7 is described with reference to list 502 of FIG. 6. Address column 642 comprises address information 646, 650, 654, and 658, etc. Based on the mapping between the elements in the list 502 and the address information of block 550 of FIG. 5, the address column 642 of index table 604 contains values as follows:

1) address information 646 contains the value, “position_{—}1”,

2) address information 650 contains the value, “position_{—}7”,

3) address information 654 contains a null value until index table 604 is updated to include information based on the list 502, for example,

4) address information 658 contains a null value until index table 604 is updated to include information based on the list 502, etc.

Similarly, index table 606 includes a data block number column 660 and an address column 662. Data block number column 660 comprises the data block numbers of the data blocks of data file 406, such as data block (3,1) 664, (3,2) 668, (3,3) 672, (3,4) 676, etc.

Address column 662 of index table 606 in FIG. 7 is described with reference to the list 502 of FIG. 6. Address column 662 comprises address information 666, 670, 674, and 678, etc. Based on the mapping between the elements in the list 502 and the address information of block 550 of FIG. 6, the address column 662 of index table 606 contains values as follows:

1) address information 666 contains the value, “position_{—}8”,

2) address information 670 contains a null value until index table 606 is updated to include information based on the list 502, for example

3) address information 674 contains a null value until index table 606 is updated to include information based on the list 502,

4) address information 678 contains the value, “position_{—}10”, etc.

Similarly, index table 608 comprises a data block number column 680 and an address column 682. Data block number column 680 comprises the data block numbers of the data blocks of data file 408, such as data block (n,1) 684, (n,2) 688, (n,3) 692, (n,4) 696, etc.

Address column 682 of index table 608 in FIG. 7 is described with reference to the list 502 of FIG. 6. Address column 682 comprises address information 686, 690, 694, and 698, etc. Based on the mapping between the elements in the list 502 and the address information of block 550 of FIG. 5, the address column 682 of index table 608 contains values as follows:

1) address information 686 contains the value, “position_{—}6”,

2) address information 690 contains the value, “position_{—}9”,

3) address information 694 contains a null value until index table 604 is updated to include information based on the list 502, for example,

4) address information 698 contains the value, “position_{—}5”, etc.

In the case where there is only one data file, only one index file is created corresponding to the one data file.

The embodiments described above with reference to FIGS. 3-7 provide The data storage mechanism of the present invention is well suited for various data types such as MPEG-2 data in a video-on-demand system, HTML data comprising static data that is broadcast from an internet web server, digital data associated with electronic catalogs, electronic delivery of stock quotes, etc. The data storage mechanism is particularly well suited in applications that require the receipt of a large number of small data files such that storage speed efficiency is far more important that file retrieval speed.

In the embodiments described above with reference to FIGS. 3-7, data blocks are stored in an order received in order to minimize total seek time during data storage. In typical applications, certain data files will be received, store, and used, and often deleted after use. Deletion of a data file corresponds to the release of a plurality of data blocks. The mechanism of FIGS. 3-7 taught that the memory locations released by the deletion should be recaptured and incorporated back into the free memory block list in order to make these available for use. However, the non-sequential nature of the file data blocks inevitably results in significant fragmentation of the available free memory. Hence as the user begins to delete files, the total seek time for storage will begin to increase as the free memory is no longer truly sequential.

In order to decrease the degradation in total seek time due to fragmentation, the present invention contemplates allocating multiple portions of persistent memory to each data file. For example, imagine that a specific file requires 16 Gigabytes of memory. The present teaching contemplates allocating 1000 16 Megabyte portions of the memory to this specific file. This is accomplished by allocating these portions of the free list to the specific file. Then upon deletion of the specific file and release of these portions of memory, the fragmentation of the file will not be so severe. Of course, it will be appreciated that another approach to minimizing fragmentation and total seek time can be accomplished by arranging the data files in large data blocks for transmission.

In the foregoing specification, the invention has been described with reference to specific embodiments thereof It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer implemented method for storing at least one digital data file arranged as a plurality of data blocks, the computer implemented method comprising the acts of:
generating a free memory block list including indirections associated with N unused blocks of persistent memory allocated for storage of said at least one digital data file;
receiving a specific data block associated with said at least one data file;
selecting a next indirection associated with a next memory block from said free memory block list;
updating said free memory block list to indicate that said next memory block is used; and
storing said specific data block at said next memory block.

2. A computer implemented method as recited in claim 1, wherein the act of generating a free memory block list comprises the act of determining whether said free memory block list has already been created.

3. A computer implemented method as recited in claim 2, wherein when said free memory block list is determined to have already been created, said act of generating a free memory block list comprises the acts of:
retrieving data file information from persistent memory; and
recreating said free memory block list from said retrieved data file information.

4. A computer implemented method as recited in claim 2, wherein when said free memory block list has not yet been created, said act of generating a free memory block list comprises the acts of:
allocating a portion of persistent memory for storage of at least one data file;
obtaining an indirection to a starting point of said allocated portion of persistent memory; and
creating said free memory block list.

5. A computer implemented method as recited in claim 4, wherein said allocated portion of persistent memory represents N memory blocks, wherein N is an integer.

6. A computer implemented method as recited in claim 5, wherein said act of creating said free memory block list includes the act of generating N indirections associate with said N memory blocks.

7. A computer implemented method as recited in claim 1, wherein the act of receiving a specific data block associated with said at least one data file includes the acts of:
receiving a given data block from a digital data server;
determining whether said given data block is required; and
discarding said given data block when said given data block is not required.

8. A computer implemented method as recited in claim 7, wherein said act of determining whether said given data block is required includes the act of determining whether said given data block has previously been received and stored.

9. A computer implemented method as recited in claim 7, wherein said act of determining whether said given data block is required includes the act of determining whether said given data block belongs to a file that has been requested by a user.

10. A computer implemented method as recited in claim 1, wherein the act of updating said free memory block list includes the act of deleting said next indirection from said free memory block list.

11. A computer implemented method as recited in claim 1, wherein the act of updating said free memory block list includes the act of marking said next indirection as used.

12. A computer implemented method as recited in claim 1, wherein said free memory block list is generated in transient memory.

13. A computer implemented method as recited in claim 12, wherein said free memory block list is periodically written into persistent memory to store and reflect updates.

14. A computer implemented method as recited in claim 1 further comprising the act of creating an index table which reflects location of the next data block such that said at least one file may be file sequentially accessed.

15. A method for managing data received in a non-sequential manner, said method decreasing total seed time for data storage, the method comprising the computer-implemented acts of:
storing said data in an order that said data is received; and
creating and maintaining index tables which enable file sequential retrieval of said stored data.

16. The method of claim 15 wherein said data comprises data blocks from a plurality of distinct data files.

17. The method of claim 15 wherein said data comprises digital data.

18. The method of claim 15 wherein each of said index tables correspond to a data file from a plurality of data files that are associated with said data.

19. The method of claim 15 wherein said index tables comprises address information corresponding to said stored data.

20. The method of claim 15 wherein said index tables are maintained in a buffer cache and in a persistent memory, wherein said buffer cache and said persistent memory is associated with a system at which said data is received.

21. The method of claim 15 wherein said index tables that are maintained in said persistent memory are periodically updated with information from said index tables that are maintained in said buffer cache.

22. A method for managing data, the method comprising the computer-implemented acts of:
receiving said data at a receiver;
storing said data in an order that said data is received to form stored data;
representing said stored data as a the list;
creating and maintaining index tables based on said the list; and
wherein;
said index tables comprises address information corresponding to said stored data; and
said index tables are used to locate said stored data.

23. A method for managing data, the method comprising the computer-implemented acts of:
storing said data in an order that said data is received to form stored data;
representing said stored data as a the list;
creating and maintaining index tables based on said the list; and
wherein;
said index tables comprises address information corresponding to said stored data;
said index tables are maintained in a buffer cache and in a persistent memory, wherein said buffer cache and said persistent memory is associated with a system at which said data is received; and
said index tables are used to locate said stored data.

24. An apparatus for managing data comprising:
computer means including:
means for storing said data in an order that said data is received to form stored data;
means for representing said stored data as a the list;
means for creating and maintaining index tables based on said the list;
wherein;
said index tables comprises address information corresponding to said stored data;
said index tables are maintained in a buffer cache and in a persistent memory, wherein said buffer cache and said persistent memory is associated with a system at which said data is received; and
said index tables are used to locate said stored data.

25. A method for managing data, the method comprising the computer-implemented acts of:
receiving said data wherein said data comprises blocks of data from a plurality of distinct data files;
storing said data in an order that said data is received to form stored data;
representing said stored data as a the list; and
creating and maintaining index tables based on said the list, wherein said index tables are used to locate said stored data.

26. A data structure for managing data that is received in a non-sequential manner, wherein:
said data comprises a plurality of data blocks from a plurality of distinct data files;
said data structure is a list;
said data structure comprises elements for storing said data; and
each of said element stores one data block from said plurality of data blocks;
each element is mapped to a corresponding address location.

27. The data structure of claim 26 wherein:
an index table is created corresponding to each of said plurality of distinct data files; and
wherein said index table contains said address information corresponding to said data blocks that correspond to one distinct data file from said plurality of distinct data files.
